(19) United States
(12) Patent Application Publication
(10) Pub. No.: US 2025/0296448 A1
(43) Pub. Date: Sep. 25, 2025

(54) Apparatus and Method for Controlling Vehicle

(71) Applicants: Hyundai Motor Company, Seoul (KR); Kia Corporation, Seoul (KR)

(72) Inventors: Sang Won Lee, Seongnam-si (KR); Sung Keun Song, Suwon-si (KR); Seong O Kang, Yongin-si (KR)

(21) Appl. No.: 18/826,288

(22) Filed: Sep. 6, 2024

(30) Foreign Application Priority Data
Mar. 21, 2024 (KR) 10-2024-0039018

(51) Int. Cl. B60L 7/18

(52) U.S. Cl. CPC B60L 7/18; B60L 2240/12; B60L 2240/24; B60L 2240/486; B60L 2250/26

(57) ABSTRACT

A vehicle control apparatus includes a processor and a storage medium storing instructions that, when executed by the processor, may cause the vehicle control apparatus to collect driving information of a vehicle, determine, based on the driving information and a plurality of distribution maps, a braking distribution ratio between a main drive axle and an auxiliary drive axle of the vehicle, determine, based on the braking distribution ratio, first regenerative braking torque for the main drive axle and second regenerative braking torque for the auxiliary drive axle, and control, based on the first regenerative braking torque and the second regenerative braking torque, regenerative braking of the vehicle.

### CROSS-REFERENCE TO RELATED APPLICATION(S)

This application claims benefit of priority to Korean Patent Application No. 10-2024-0039018 filed on Mar. 21, 2024 in the Korean Intellectual Property Office, the disclosure of which is incorporated herein by reference in its entirety.

### BACKGROUND

### 1. Field

The present disclosure relates to an apparatus and method for controlling vehicle.

### 2. Description

Electrified vehicles are vehicles equipped with an electric motor for propulsion. Electrified vehicles may include hybrid vehicles, electric vehicles, and hydrogen fuel cell vehicles. Regenerative braking technology has been used to increase the fuel efficiency of such electrified vehicles.

Regenerative braking is a technology for generating electrical energy by applying reverse torque to an electric motor and using the energy generated when a vehicle brakes and storing the generated electrical energy in a high-voltage battery for reuse when driving the vehicle.

For a four-wheel drive (4WD) vehicle with independent driving devices applied to front and rear wheels, the driving devices may be driven independently or together. For example, a two-wheel drive (2WD) mode, in which with either the front or rear wheels are powered as one axle, is executed as basic driving, and if driving power is insufficient, the four-wheel drive mode may be activated to additionally utilize the remaining axle.

Therefore, vehicles may use one of a front-wheel drive axle and a rear-wheel drive axle as a main drive axle and the other as an auxiliary drive axle. In some implementations, when four-wheel drive is implemented, regenerative braking torque may be applied only to the main drive axle, and a portion of the regenerative braking torque may be applied to the auxiliary drive axle only under special circumstances.

According to these implementations, if regenerative braking torque is excessively applied to either of the drive axles, wheel slip may occur, thereby impairing vehicle safety, and ultimately, the regenerative braking torque may be released and a loss of fuel efficiency may occur.

### SUMMARY

An aspect of the present disclosure is to provide an apparatus and method for controlling vehicle capable of improving braking safety by appropriately distributing and applying regenerative braking power to a main drive axle and an auxiliary drive axle.

Another aspect of the present disclosure is to provide an apparatus and method for controlling vehicle capable of implementing regenerative braking optimized for a driving situation of a vehicle by deriving a braking distribution ratio between a main drive axle and an auxiliary drive axle of the vehicle using driving information of the vehicle and a plurality of distribution maps and controlling regenerative braking of the drive axle and the auxiliary drive axle using regenerative braking torque derived based on the braking distribution ratio.

Another aspect of the present disclosure is to provide an apparatus and method for controlling vehicle capable of improving the degree of freedom in tuning a distribution ratio by deriving, as a braking distribution ratio, one of a plurality of distribution ratio candidate values output from a plurality of different distribution maps.

According to one or more example embodiments of the present disclosure, a vehicle control apparatus may include: a processor and a storage medium. The storage medium may store instructions that, when executed by the processor, cause the vehicle control apparatus to: collect driving information of a vehicle; determine, based on the driving information and a plurality of distribution maps, a braking distribution ratio between a main drive axle and an auxiliary drive axle of the vehicle; determine, based on the braking distribution ratio, first regenerative braking torque for the main drive axle and second regenerative braking torque for the auxiliary drive axle; and control, based on the first regenerative braking torque and the second regenerative braking torque, regenerative braking of the vehicle.

The instructions, when executed by the processor, may cause the vehicle control apparatus to determine the braking distribution ratio by: determining, based on the plurality of distribution maps, a plurality of distribution ratio candidate values; and selecting, based on main drive axle information of the vehicle, one of the plurality of distribution ratio candidate values as the braking distribution ratio.

The plurality of distribution maps may include a distribution map for fuel efficiency and drivability of the vehicle. The instructions, when executed by the processor, may further cause the vehicle control apparatus to: input, into the distribution map, required driving amount information included in the driving information; and determine, based on an output from the distribution map, a distribution ratio candidate value.

The plurality of distribution maps may include a distribution map for braking safety associated with the vehicle turning at a high speed. The instructions, when executed by the processor, may further cause the vehicle control apparatus to: input, into the distribution map, vehicle speed information and steering angle information included in the driving information; and determine, based on an output from the distribution map, a distribution ratio candidate value.

The plurality of distribution maps may include a distribution map for braking safety associated with the vehicle decelerating at a high speed. The instructions, when executed by the processor, may further cause the vehicle control apparatus to: input, into the distribution map, vehicle speed information and required braking amount information included in the driving information; and determine, based on an output from the distribution map, a distribution ratio candidate value.

The instructions, when executed by the processor, may cause the vehicle control apparatus to determine the braking distribution ratio by: determining the braking distribution ratio, for a front-wheel drive axle, to be one of: a minimum value, of the plurality of distribution ratio candidate values, based on the main drive axle of the vehicle being the front-wheel drive axle, or a maximum value, of the plurality of distribution ratio candidate values, based on the main drive axle of the vehicle being a rear-wheel drive axle.

The instructions, when executed by the processor, may further cause the vehicle control apparatus to: determine, based on the braking distribution ratio, a main drive axle distribution ratio and an auxiliary drive axle distribution ratio; determine, based on a signal detected by a brake pedal sensor of the vehicle, a total required braking amount; and determine an allowable predicted value of regenerative braking of the main drive axle and an allowable predicted value of regenerative braking of the auxiliary drive axle, based on the total required braking amount, the main drive axle distribution ratio, and the auxiliary drive axle distribution ratio.

The instructions, when executed by the processor, may further cause the vehicle control apparatus to: determine, based on the main drive axle distribution ratio, cost regenerative torque for the main drive axle; and determine, based on the auxiliary drive axle distribution ratio, cost regenerative torque for the auxiliary drive axle.

The instructions, when executed by the processor, may cause the vehicle control apparatus to determine the first regenerative braking torque and the second regenerative braking torque by: determining an allowable amount of regenerative braking of the main drive axle and an allowable amount of regenerative braking of the auxiliary drive axle, based on the allowable predicted value of regenerative braking of the main drive axle, the allowable predicted value of regenerative braking of the auxiliary drive axle, the cost regenerative torque for the main drive axle, and the cost regenerative torque for the auxiliary drive axle; determining the first regenerative braking torque for the main drive axle further based on the allowable amount of regenerative braking of the main drive axle; and determining the second regenerative braking torque for the auxiliary drive axle further based on the allowable amount of regenerative braking of the auxiliary drive axle.

The instructions, when executed by the processor, may further cause the vehicle control apparatus to: adjust the braking distribution ratio based on whether a disconnector, which is configured to disconnect the auxiliary drive axle from a motor, is operational.

According to one or more example embodiments of the present disclosure, a vehicle control method may be performed by a computing device including a processor. The vehicle control method may include: collecting driving information of a vehicle; determining, based on the driving information and a plurality of distribution maps, a braking distribution ratio between a main drive axle and an auxiliary drive axle of the vehicle; determining, based on the braking distribution ratio, first regenerative braking torque for the main drive axle and second regenerative braking torque for the auxiliary drive axle; and controlling, based on the first regenerative braking torque and the second regenerative braking torque, regenerative braking of the vehicle.

Determining the braking distribution ratio may include: determining, based on the plurality of distribution maps, a plurality of distribution ratio candidate values; and selecting, based on main drive axle information of the vehicle, one of the plurality of distribution ratio candidate values as the braking distribution ratio.

The plurality of distribution maps may include a distribution map for fuel efficiency and drivability of the vehicle. The method may further include: input, into the distribution map, required driving amount information included in the driving information; and determining, based on an output from the distribution map, a distribution ratio candidate value.

The plurality of distribution maps may include a distribution map for braking safety associated with the vehicle turning at a high speed. The method further include: inputting, into the distribution map, vehicle speed information and steering angle information included in the driving information; and determining, based on an output from the distribution map, a distribution ratio candidate value.

The plurality of distribution maps may include a distribution map for braking safety associated with the vehicle decelerating at a high speed. The method may further include: inputting, into the distribution map, vehicle speed information and required braking amount information included in the driving information; and determining, based on an output from the distribution map, a distribution ratio candidate value.

Determining the braking distribution ratio may include: determining the braking distribution ratio, for a front-wheel drive axle, to be one of: a minimum value, of the plurality of distribution ratio candidate values, based on the main drive axle of the vehicle being the front-wheel drive axle, or a maximum value, of the plurality of distribution ratio candidate values, based on the main drive axle of the vehicle being a rear-wheel drive axle.

The vehicle control method may further include: determining, based on the braking distribution ratio, a main drive axle distribution ratio and an auxiliary drive axle distribution ratio; determining, based on a signal detected by a brake pedal sensor of the vehicle, a total required braking amount; and determining an allowable predicted value of regenerative braking of the main drive axle and an allowable predicted value of regenerative braking of the auxiliary drive axle, based on the total required braking amount, the main drive axle distribution ratio, and the auxiliary drive axle distribution ratio.

The vehicle control method may further include: determining, based on the main drive axle distribution ratio, cost regenerative torque for the main drive axle; and determining, based on the auxiliary drive axle distribution ratio, cost regenerative torque for the auxiliary drive axle.

Determining the first regenerative braking torque and the second regenerative braking torque may include: determining an allowable amount of regenerative braking of the main drive axle and an allowable amount of regenerative braking of the auxiliary drive axle, based on the allowable predicted value of regenerative braking of the main drive axle, the allowable predicted value of regenerative braking of the auxiliary drive axle, the cost regenerative torque for the main drive axle, and the cost regenerative torque for the auxiliary drive axle; determining the first regenerative braking torque for the main drive axle further based on the allowable amount of regenerative braking of the main drive axle; and determining the second regenerative braking torque for the auxiliary drive axle further based on the allowable amount of regenerative braking of the auxiliary drive axle.

The vehicle control method may further include: adjusting the braking distribution ratio based on whether a disconnector, which is configured to disconnect the auxiliary drive axle from a motor, is operational.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 schematically illustrates a vehicle including a vehicle control apparatus according to an embodiment of the present disclosure;

FIG. 2 is a block diagram of a vehicle control apparatus according to an embodiment of the present disclosure;

FIG. 3 is a flowchart of a vehicle control method according to an embodiment of the present disclosure;

FIG. 4 is a flowchart of a vehicle control method according to an embodiment of the present disclosure;

FIG. 5 is a flowchart illustrating a vehicle control method according to an embodiment of the present disclosure; and

FIG. 6 is a block diagram of a computing device that may fully or partially implement a vehicle control apparatus according to an embodiment of the present disclosure.

### DETAILED DESCRIPTION

Hereinafter, embodiments of the present disclosure are described with reference to the accompanying drawings. The following description is provided to aid in the comprehensive understanding of methods, devices, and/or systems disclosed in the particularities. However, the following description is merely exemplary and not provided to limit the present disclosure.

In the following description of the present disclosure, a detailed description of known functions and configurations incorporated herein will be omitted when it would render the subject matter of the present disclosure unclear. The terms used in the present specification are defined in consideration of functions used in the present disclosure, and may be changed according to the intent or conventionally used methods of clients, operators, and users. Accordingly, definitions of the terms should be understood on the basis of the entire description of the present specification. Terms used in the following description are merely provided to describe embodiments of the present disclosure and are not intended to be limiting of the inventive concept. As used herein, the singular forms “a,” “an” and “the” are intended to include the plural forms as well, unless the context clearly indicates otherwise. It will be further understood that the terms “comprises” or “has” when used in this specification, specify the presence of stated features, integers, steps, operations, elements, or a portion or combination thereof, but do not preclude the presence or addition of one or more other features, integers, steps, operations, elements, or a portion or combination thereof.

It will be understood that when an element is referred to as being “connected to” another element, it may be directly connected to the other element or intervening elements may also be present. In contrast, when an element is referred to as being “directly connected to” another element, no intervening elements are present.

Hereinafter, specific embodiments of the present disclosure will be described with reference to the drawings.

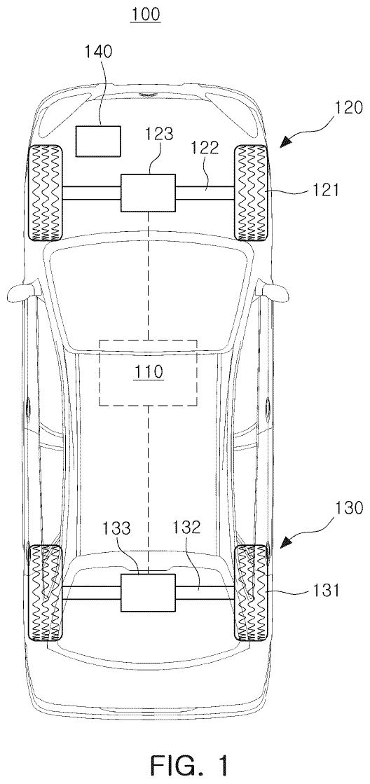

FIG. 1 schematically illustrates a vehicle including a vehicle control apparatus according to an embodiment of the present disclosure. Referring to FIG. 1, a vehicle 100 may include a vehicle control apparatus 110, a front wheel drive unit 120, a rear wheel drive unit 130, and a sensor unit 140.

The vehicle 100 may be a 4-wheel drive vehicle including a front-wheel drive unit 120 and a rear-wheel drive unit 130. In addition, the vehicle 100 may be an electric vehicle capable of performing regenerative braking control.

The vehicle control apparatus 110 may generate a signal for controlling the vehicle 100 based on information received from other components of the vehicle 100, including the front wheel drive unit 120, the rear wheel drive unit 130, and the sensor unit 140. The vehicle control apparatus 110 may transmit the generated control signal to other components of the vehicle 100 through a controller area network (CAN) signal.

The front wheel drive unit 120 may include a front wheel 121, a front-wheel drive axle 122, and a front wheel motor 123. The front wheel drive unit 120 may be disposed at the front of the vehicle 100 to generate power to drive the vehicle 100 and transmit power to the front wheel 121 through the front-wheel drive axle 122.

The rear wheel drive unit 130 may include a rear wheel 131, a rear-wheel drive axle 132, and a rear wheel motor 133. The rear wheel drive unit 130 may be disposed at the rear of the vehicle 100 to generate power to drive the vehicle 100 and transmit power to the rear wheel 131 through the rear-wheel drive axle 132.

The vehicle 100 may use one of the front wheel 121 and the rear wheel 131 as a main drive wheel and the other as an auxiliary drive wheel.

For example, in the case of a rear-wheel-based vehicle with the rear wheel 131 as the main drive wheel, the rear-wheel drive axle 132 may be the main drive axle, and the front-wheel drive axle 122 may be the auxiliary drive axle.

For another example, in the case of a front-wheel-based vehicle with the front wheel 121 as the main drive wheel, the front-wheel drive axle 122 may be the main drive axle, and the rear-wheel drive axle 132 may be the auxiliary drive axle.

The vehicle 100 may further include a disconnector separating connection between the auxiliary drive axle and a motor and allows a driving method of the vehicle 100 to be switched. The disconnector may connect the auxiliary drive axle to the motor or disconnect the auxiliary drive axle from the motor, according to preset disconnector operating conditions.

The preset disconnector operating conditions may include a case in which wheel slip occurs while the vehicle is driving. For example, the preset disconnector operating conditions may include a case which a required deceleration is 0.2 g or more.

For example, in the case of a rear-wheel-based vehicle, the disconnector may be included on the front-wheel drive unit 120 side and connect or disconnect the front-wheel drive axle 122 and the front-wheel motor 123 according to preset disconnector operating conditions.

For another example, in the case of a front-wheel-based vehicle, the disconnector may be included on the rear-wheel drive unit 130 side and connect or disconnect the rear-wheel drive axle 132 and the rear-wheel motor 133 according to preset disconnector operating conditions.

When the disconnector is not operated according to the preset disconnector operating conditions, that is, when the auxiliary drive axle is connected to the motor, the vehicle 100 may be operated in a four-wheel drive mode. In addition, when the disconnector is operated according to the preset disconnector operating conditions, that is, when the auxiliary drive axle is disconnected from the motor, the vehicle 100 may be operated in a two-wheel drive mode.

The sensor unit 140 may include one or more sensors collecting driving information of the vehicle 100. The sensor unit 140 may include at least one of, for example, a wheel speed sensor, a vehicle speed sensor detecting a speed of the vehicle 100, an accelerator position sensor (APS) linked to an operation of an accelerator pedal, a brake pedal sensor (BPS) linked to an operation of a brake pedal, and a steering angle sensor (SAS) linked to a steering wheel operation.

The sensor unit 140 may transmit the collected driving information of the vehicle 100 to the vehicle control apparatus 110 through a CAN signal.

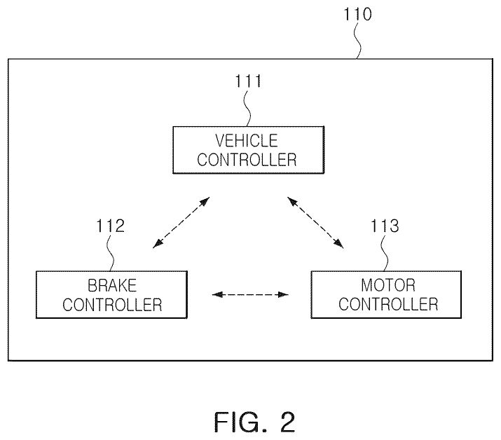

Hereinafter, the configuration and operation of the vehicle control apparatus 110 are described in detail. FIG. 2 illustrates a block diagram of the vehicle control apparatus 110. As illustrated in FIG. 2, the vehicle control apparatus 110 may include a vehicle controller 111, a brake controller 112, and a motor controller 113.

The vehicle controller 111 may control various components necessary to control starting, power, braking, steering, and shifting of the vehicle 100. The vehicle controller 111 may control the brake controller 112 and the motor controller 113 and may control other components of the vehicle 100 in cooperation with at least one of the brake controller 112 and the motor controller 113.

The brake controller 112 may slow down a driving speed of the vehicle 100 or stop the vehicle 100 by controlling a braking device of the vehicle 100 based on a signal from the brake pedal sensor. In addition, the motor controller 113 may control a driving speed of the vehicle 100 by controlling a driving device including the front wheel motor 123 and the rear wheel motor 133 of the vehicle 100 based on a signal from the accelerator position sensor.

The vehicle control apparatus 110 may further include a storage unit and a communication unit. The storage unit may store various programs and data to implement functions performed by the vehicle controller 111, the brake controller 112, and the motor controller 113. The communication unit may be used by the vehicle controller 111, the brake controller 112, and the motor controller 113 to transmit and receive data with each other or with other components of the vehicle 100.

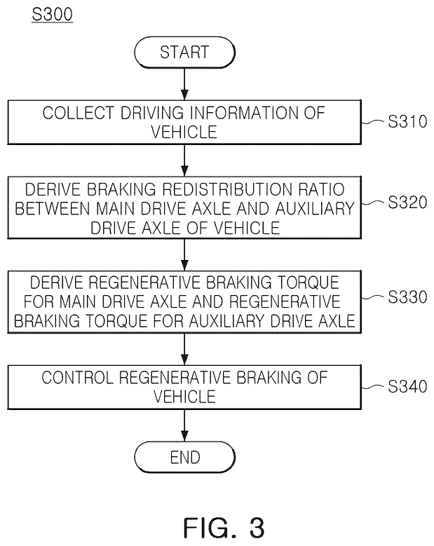

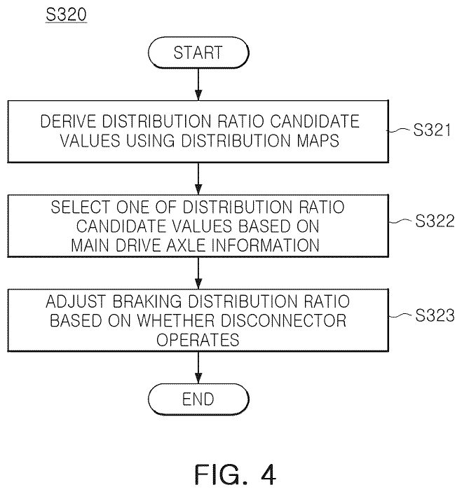

FIGS. 3 and 4 are flowcharts of a vehicle control method according to an embodiment of the present disclosure. The vehicle control method illustrated in FIGS. 3 and 4 may be performed in whole or in part by the vehicle control apparatus 110 illustrated in FIGS. 1 and 2.

Referring to FIG. 3, the vehicle control method (S300) may include an operation (S310) of collecting driving information of a vehicle, an operation (S320) of deriving a braking distribution ratio between a main drive axle and an auxiliary drive axle of the vehicle, an operation (S330) of deriving regenerative braking torque for the main drive axle and regenerative braking torque for the auxiliary drive axle, and an operation (S340) of controlling regenerative braking of the vehicle.

In the operation (S310) of collecting driving information of the vehicle, driving information of the vehicle may be collected based on signals detected from one or more sensors included in the vehicle.

One or more sensors included in the vehicle may include, for example, at least one of the wheel speed sensor, the vehicle speed sensor, the accelerator position sensor, the brake pedal sensor, and the steering angle sensor.

The driving information of the vehicle may include at least one of, for example, vehicle speed information based on the detection signal from the vehicle speed sensor, required driving amount information based on the detection signal from the accelerator position sensor, required braking amount information based on the detection signal from the brake pedal sensor, and steering angle information based on the detection signal from the steering angle sensor.

In the operation (S320) of deriving the braking distribution ratio, a braking distribution ratio between the main drive axle and the auxiliary drive axle of the vehicle may be derived using the driving information of the vehicle and a plurality of distribution maps collected in operation S310.

FIG. 4 illustrates a detailed flowchart of the operation (S320) of deriving the braking distribution ratio included in the vehicle control method (S300).

Referring to FIG. 4, the operation (S320) of deriving the braking distribution ratio may include an operation (S321) of deriving a plurality of distribution ratio candidate values using a plurality of distribution maps, an operation (S322) of selecting one of the plurality of distribution ratio candidate values based on the main drive axle information, and an operation (S323) of adjusting the braking distribution ratio based on whether the disconnector is operational.

The plurality of distribution maps may include different distribution maps configured to derive different output values in consideration of a driving situation of the vehicle.

For example, the plurality of distribution maps include a first distribution map for fuel efficiency and drivability of the vehicle, a second distribution map for braking safety when the vehicle turns at a high speeds, and a third distribution map for braking safety when the vehicle decelerates at a high speed.

The operation (S321) of deriving a plurality of distribution ratio candidate values may include an operation of inputting the required driving amount information included in the driving information into the first distribution map and an operation of deriving a first distribution ratio candidate value output from the first distribution map. The first distribution map is for the fuel efficiency and drivability of the vehicle and may output the first distribution ratio candidate value allowing a high rate of regenerative braking torque to be applied to the main drive axle of the vehicle as much as possible.

In addition, the operation (S321) of deriving a plurality of distribution ratio candidate values may include an operation of inputting vehicle speed information and steering angle information included in the driving information into the second distribution map and an operation of deriving a second distribution ratio candidate value output from the second distribution map. The second distribution map is for the braking stability of the vehicle and may output the second distribution ratio candidate value allowing a high rate of regenerative braking torque to be applied to the auxiliary drive axle when the vehicle turns at a high speed.

In addition, the operation (S321) of deriving a plurality of distribution ratio candidate values may include an operation of inputting vehicle speed information and required braking amount information included in the driving information into the third distribution map and an operation of deriving a third distribution ratio output from the third distribution map. The third distribution map is for the braking stability of the vehicle and may output a third distribution ratio candidate value allowing a high rate of regenerative braking torque to be applied to the auxiliary drive axle when the vehicle decelerates at a high speed.

The first to third distribution maps described above are examples of a plurality of distribution maps, and the plurality of distribution maps may include all or some of the first to third distribution maps or may include another distribution map processed in a different manner from the first to third distribution maps.

In the operation (S322) of selecting one of the plurality of distribution ratio candidate values, one of the plurality of distribution ratio candidate values may be determined as a braking distribution ratio based on the main drive axle information of the vehicle.

For example, when the main drive axle of the vehicle is the rear-wheel drive axle, a maximum value among the plurality of distribution ratio candidate values may be determined as a braking distribution ratio for the rear-wheel drive axle.

For another example, when the main drive axle of the vehicle is a front-wheel drive axle, a minimum value among the plurality of distribution ratio candidate values may be determined as a braking distribution ratio for the front-wheel drive axle.

According to the present disclosure, the braking distribution ratio may be determined so that the regenerative braking amount is not excessively applied to any one drive axle, especially, the main drive axle, and the regenerative braking amount is appropriately distributed and applied to the main drive axle and the auxiliary drive axle, thereby preventing the occurrence of wheel slip and improving braking safety.

The operation (S320) of deriving a braking distribution ratio may further include detecting whether the disconnector, which is configured to disconnect between the auxiliary drive axle and the motor, is operational.

In the operation (S323) of adjusting the braking distribution ratio based on whether the disconnector is operational, if the disconnector is not operational, the auxiliary drive axle may be connected to the motor and the braking distribution ratio determined in operation S322 may be applied as is.

Meanwhile, when the disconnector is operational, the auxiliary drive axle is separated from the motor and the braking distribution ratio determined in operation S322 may not be applied as is, and thus, the main drive axle distribution ratio may be adjusted to be 1 and the auxiliary drive axle distribution ratio may be adjusted to 0.

Referring back to FIG. 3, the operation (S320) of deriving a braking distribution ratio may include an operation of deriving a main drive axle distribution ratio and an operation of deriving an auxiliary drive axle distribution ratio. The main drive axle distribution ratio may be applied to the main drive axle of the vehicle and the auxiliary drive axle distribution ratio may be applied to the auxiliary drive axle, and the sum of the main drive axle distribution ratio and the auxiliary drive axle distribution ratio may be set to have a value of 1.

For example, if the main drive axle of the vehicle is a rear-wheel drive axle and the maximum value among the plurality of distribution ratio candidate values is determined as a braking distribution ratio for the front-wheel drive axle, the braking distribution ratio for the front-wheel drive axle may be the auxiliary drive axle distribution ratio. Therefore, the ratio (1-auxiliary drive axle distribution ratio) corresponding to the remainder of the auxiliary drive axle distribution ratio may be the main drive axle distribution ratio and may be applied to the rear-wheel drive axle.

In another example, when the main drive axle of the vehicle is a front-wheel drive axle and the minimum value among the plurality of distribution ratio candidate values is determined as a braking distribution ratio for the front-wheel drive axle, the braking distribution ratio for the front-wheel drive axle may be the main drive axle distribution ratio. Therefore, the ratio (1-main drive axle distribution ratio) corresponding to the remainder of the main drive axle distribution ratio may be the auxiliary drive axle distribution ratio and may be applied to the rear-wheel drive axle.

In addition, the vehicle control method (S300) may further include an operation of deriving a total required braking amount, an operation of deriving an allowable predicted value of regenerative braking, an operation of controlling cost regenerative torque, and an operation of deriving an allowable amount of regenerative braking.

In the operation of deriving the total required braking amount, a total required braking amount may be derived based on a signal detected by the brake pedal sensor of the vehicle. The total required braking amount may refer to the total amount of braking required for the vehicle to slow down or stop the vehicle based on a stroke of a brake pedal input from the driver.

In the operation of deriving the allowable predicted value of regenerative braking, an allowable predicted value of regenerative braking of the main drive axle and an allowable predicted value of regenerative braking of the auxiliary drive axle may be derived based on the total required braking amount, the main drive axle distribution ratio, and the auxiliary drive axle distribution ratio. The allowable predicted value of regenerative braking may refer to a predicted value of the allowable amount of regenerative braking applicable to the main drive axle and auxiliary drive axle of the vehicle.

For example, the allowable regenerative braking value of the main drive axle may be derived by multiplying the total required braking amount by the main drive axle distribution ratio, and the allowable regenerative braking value of the auxiliary drive axle may be derived as a value obtained by subtracting the allowable predicted value of regenerative braking of the main drive axle from the total required braking amount.

In addition, the allowable predicted value of regenerative braking of the main drive axle may be derived as a value obtained by multiplying the total required braking amount by the main drive axle distribution ratio, and the allowable predicted value of regenerative braking of the auxiliary drive axle may be derived as a value obtained by multiplying the total required braking amount by the auxiliary drive axle distribution ratio.

In the operation of controlling the cost regenerative torque, the main drive axle distribution ratio and the auxiliary drive axle distribution ratio may be equally applied to the cost regenerative control of the main drive axle and the auxiliary drive axle.

The operation of controlling the cost regenerative torque may include an operation of deriving cost regenerative torque for the main drive axle based on the main drive axle distribution ratio and an operation of deriving cost regenerative torque for the auxiliary drive axle based on the auxiliary drive axle distribution ratio.

In the operation of controlling cost regenerative torque, cost regenerative control may be performed based on the cost regenerative torque for the main drive axle and the cost regenerative torque for the auxiliary drive axle.

The present disclosure has the effect of improving fuel efficiency and vehicle safety by deriving an appropriate braking distribution ratio according to a driving situation of the vehicle and appropriately distributing and applying the cost regenerative amount to the main drive axle and the auxiliary drive axle using the same braking distribution ratio.

In the operation of deriving the allowable amount of regenerative braking, an allowable amount of regenerative braking of the main drive axle and an allowable amount of regenerative braking of the auxiliary drive axle may be derived based on the allowable predicted value of regenerative braking of the main drive axle, the allowable predicted value of regenerative braking of the auxiliary drive axle, the cost regenerative torque for the main drive axle, and the cost regenerative torque for the auxiliary drive axle.

The allowable amount of regenerative braking may refer to the regenerative braking amount applicable to the main drive axle and auxiliary drive axle of the vehicle in consideration of a number of factors including the total required braking amount of the vehicle, the execution amount of cost regenerative, and the limitations of the vehicle itself.

In the operation (S330) of deriving regenerative braking torque, regenerative braking torque for the main drive axle and regenerative braking torque for the auxiliary drive axle may be derived based on the braking distribution ratio derived in operation S320.

The operation (S330) of deriving regenerative braking torque may include an operation of deriving regenerative braking torque for the main drive axle based on the allowable amount of regenerative braking of the main drive axle and deriving regenerative braking torque for the auxiliary drive axle based on the allowable amount of regenerative braking of the auxiliary drive axle.

The regenerative braking torque for the main drive axle may be derived within a range of the allowable amount of regenerative braking of the main drive axle, and the regenerative braking torque for the auxiliary drive axle may be derived within a range of the allowable amount of regenerative braking of the auxiliary drive axle.

In the operation (S340) of controlling regenerative braking of the vehicle, regenerative braking of the vehicle may be controlled based on the regenerative braking torque for the main drive axle and the regenerative braking torque for the auxiliary drive axle derived in operation S330.

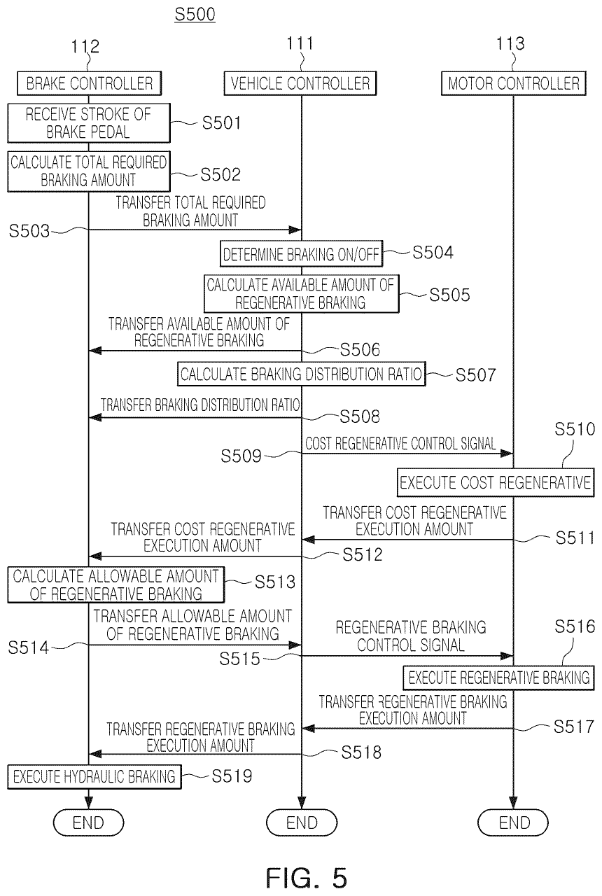

FIG. 5 is a flowchart illustrating a vehicle control method according to an embodiment of the present disclosure. A vehicle control method (S500) illustrated in FIG. 5 may be implemented by the vehicle control apparatus 110 according to an embodiment of the present disclosure.

Specifically, FIG. 5 illustrates the operations of the vehicle controller 111, the brake controller 112, and the motor controller 113 included in the vehicle control apparatus 110 and data flow.

In FIG. 5, a detailed description of the same part as that described above with reference to FIGS. 1 to 4 is omitted.

Referring to FIG. 5, in the vehicle control method (S500), a stroke of a brake pedal is input by the brake controller 112 (S501), and a total required braking amount may be calculated (S502). The total required braking amount calculated by the brake controller 112 may be transferred from the brake controller 112 to the vehicle controller 111 (S503).

Subsequently, braking ON/FF may be determined by the vehicle controller 111 (S504), and an available regenerative amount may be calculated (S505). The available braking regenerative braking amount calculated by the vehicle controller 111 may be transferred from the vehicle controller 111 to the braking controller 112 (S506).

In addition, a braking distribution ratio may be calculated by the vehicle controller 111 (S507). The braking distribution ratio calculated by the vehicle controller 111 may be transferred from the vehicle controller 111 to the brake controller 112 (S508).

A cost regenerative control signal may be transmitted from the vehicle controller 111 to the motor controller 113 (S509), and cost regenerative may be executed by the motor controller 113 (S510).

A cost regenerative execution amount may be transferred from the motor controller 113 to the vehicle controller 111 (S511), and the cost regenerative execution amount may be transferred from the vehicle controller 111 to the brake controller 112 (S512).

Subsequently, an allowable amount of regenerative braking may be calculated by the braking controller 112 (S513). The allowable amount of regenerative braking calculated by the brake controller 112 may be transferred from the brake controller 112 to the vehicle controller 111 (S514).

A regenerative braking control signal may be transferred from the vehicle controller 111 to the motor controller 113 (S515), and regenerative braking may be performed by the motor controller 113 (S516).

The regenerative braking execution amount may be transferred from the motor controller 113 to the vehicle controller 111 (S517), and the regenerative braking execution amount may be transferred from the vehicle controller 111 to the brake controller 112 (S518).

Subsequently, hydraulic braking may be performed by the braking controller 112 (S519). A control signal for hydraulic braking may be determined based on a value obtained by subtracting the regenerative braking execution amount from the total required braking amount.

In the flowchart of the vehicle control method (S500) illustrated in FIG. 5, the division of the operations of the vehicle controller 111, the braking controller 112, and the motor controller 113 is an example, and in reality, the vehicle control method (S500) may be implemented such that all the operations may be performed by one of the vehicle controller 111, the brake controller 112, and the motor controller 113 or may be divided to be performed.

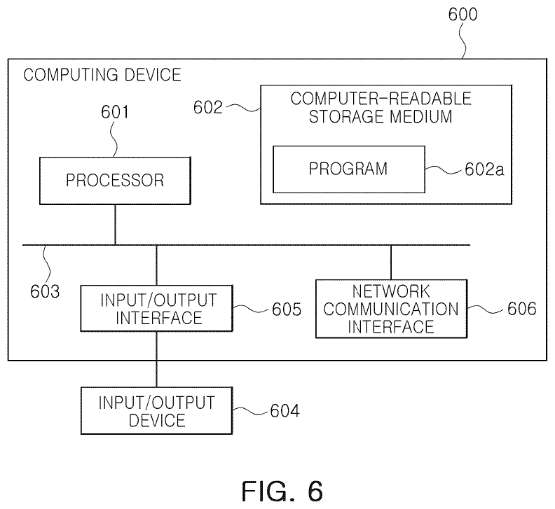

FIG. 6 is a block diagram of a computing device 600 that may fully or partially implement a vehicle control apparatus according to an embodiment of the present disclosure, which may be the vehicle control apparatus 110 illustrated in FIGS. 1 and 2.

As illustrated in FIG. 6, the computing device 600 includes at least one processor 601, a computer-readable storage medium 602, and a communication bus 603.

The processor 601 may enable the computing device 600 to operate according to the exemplary embodiments mentioned above. For example, the processor 601 may execute one or more programs stored in the computer-readable storage medium 602. The one or more programs may include one or more computer-executable instructions, which, when executed by the processor 601, may cause the computing device 600 to perform the operations according to exemplary embodiments.

The computer-readable storage medium 602 is configured to store computer-executable instructions or program code, program data, and/or other suitable forms of information. A program 602a stored in the computer-readable storage medium 602 includes a set of instructions executable by the processor 601. In an embodiment, the computer-readable storage medium 602 includes memory (volatile memory, such as random access memory, non-volatile memory, or appropriate combinations thereof), one or more magnetic disk storage devices, optical disk storage devices, flash memory devices, another form of storage medium that may be accessed by the computing device 600 and store desired information, or suitable combinations thereof.

The communication bus 603 interconnects various other components of the computing device 600, including the processor 601 and the computer-readable storage medium 602.

The computing device 600 may also include one or more input/output interfaces 605 providing an interface for one or more input/output devices 604 and one or more network communication interfaces 606. The input/output interface 605 and the network communication interface 606 are connected to the communication bus 603.

The network communication interface 606 is an interface for communication within the vehicle or an interface for communication between the vehicle and other devices than the vehicle. For example, the network communication interface 606 may include CAN, media oriented systems transport (MOST) network, local interconnect network (LIN) and/or X-by-Wire (Flexray), Wi-Fi, Bluetooth, NFC, RFID, etc. The network may be a cellular network, for example, global system for mobile communications (GSM), enhanced data rates for GSM evolution (EDGE), general packet radio service (GPRS), code division multiple access (CDMA), time division-CDMA (TD-CDMA), universal mobile telecommunications system (UMTS), long term evolution (LTE), or other cellular networks.

The input/output device 604 may be connected to other components of the computing device 600 through the input/output interface 605. For example, the input/output devices 604 may include, but are not limited to, a pointing device (such as a mouse or trackpad), a keyboard, a touch input device (such as a touchpad or touch screen), a voice or sound input device, various types of sensor devices, and/or input devices such as imaging devices, and/or output devices, such as display devices, printers, speakers, and/or network cards. The input/output device 604 may be included within the computing device 600 as a component constituting the computing device 600 or may be connected to the computing device 600 as a separate device distinct from the computing device 600.

According to an aspect of the present disclosure, a vehicle control apparatus includes: a processor and a storage medium storing an instruction executable by the processor, wherein the processor is configured to execute the instruction to collect driving information of a vehicle, derive a braking distribution ratio between a main drive axle and an auxiliary drive axle of the vehicle using the driving information and a plurality of distribution maps, derive regenerative braking torque for the main drive axle and regenerative braking torque for the auxiliary drive axle based on the braking distribution ratio, and control regenerative braking of the vehicle based on the regenerative braking torque for the main drive axle and the regenerative braking torque for the auxiliary drive axle.

According to another aspect of the present disclosure, a vehicle control method, performed in a computing device including a processor and a storage medium storing an instruction executable by the processor, includes collecting driving information of a vehicle, deriving a braking distribution ratio between the main drive axle and the auxiliary drive axle of the vehicle using the driving information and a plurality of distribution maps, deriving regenerative braking torque for the main drive axle and regenerative braking torque for the auxiliary drive axle based on the braking distribution ratio, and controlling regenerative braking of the vehicle based on the regenerative braking torque for the main drive axle and the regenerative braking torque for the auxiliary drive axle.

The present disclosure may provide the apparatus and method for controlling vehicle capable of improving braking safety by appropriately distributing and applying regenerative braking amount to the main drive axle and auxiliary drive axle.

In an embodiment, the present disclosure may provide the apparatus and method for controlling vehicle capable of implementing regenerative braking optimized for a driving situation of a vehicle by deriving a braking distribution ratio between a main drive axle and an auxiliary drive axle of the vehicle using driving information of the vehicle and a plurality of distribution maps and controlling regenerative braking of the drive axle and auxiliary drive axle using regenerative braking torque derived based on the braking distribution ratio.

The present disclosure may provide the apparatus and method for controlling vehicle capable of improving the degree of freedom in tuning a distribution ratio by deriving, as a braking distribution ratio, one of a plurality of distribution ratio candidate values output from a plurality of different distribution maps and capable of improving fuel efficiency by utilizing front and rear motors as much as possible.

In addition, the present disclosure may improve fuel efficiency by appropriately distributing and applying the cost regenerative amount to the main drive axle and the auxiliary drive axle using the same braking distribution ratio as that of regenerative braking.

Meanwhile, the embodiments of the present disclosure may include a program for performing the methods described in this specification on a computer and a computer-readable recording medium including the program. The computer-readable recording medium may include program instructions, local data files, local data structures, etc., alone or in combination. The medium may be those specifically designed and configured for the present disclosure or may be those commonly available in the computer software field. Examples of computer-readable recording medium include magnetic medium, such as hard disks, floppy disks, and magnetic tapes, optical recording medium, such as CD-ROMs, DVDs, and hardware devices specifically configured to store and perform program instructions, such as ROM, RAM, flash memory, etc. Examples of the program may include not only machine language code, such as that generated by a compiler, but also high-level language code that may be executed by a computer using an interpreter or the like.

While exemplary embodiments have been shown and described above, it will be apparent to those skilled in the art that modifications and variations could be made without departing from the scope of the present disclosure as defined by the appended claims.

What is claimed is:

1. A vehicle control apparatus comprising:
a processor; and
a storage medium storing instructions that, when executed by the processor, cause the vehicle control apparatus to:
collect driving information of a vehicle;
determine, based on the driving information and a plurality of distribution maps, a braking distribution ratio between a main drive axle and an auxiliary drive axle of the vehicle;
determine, based on the braking distribution ratio, first regenerative braking torque for the main drive axle and second regenerative braking torque for the auxiliary drive axle; and
control, based on the first regenerative braking torque and the second regenerative braking torque, regenerative braking of the vehicle.

2. The vehicle control apparatus of claim 1, wherein the instructions, when executed by the processor, cause the vehicle control apparatus to determine the braking distribution ratio by:
determining, based on the plurality of distribution maps, a plurality of distribution ratio candidate values; and
selecting, based on main drive axle information of the vehicle, one of the plurality of distribution ratio candidate values as the braking distribution ratio.

3. The vehicle control apparatus of claim 1, wherein the plurality of distribution maps comprise a distribution map for fuel efficiency and drivability of the vehicle, and
wherein the instructions, when executed by the processor, further cause the vehicle control apparatus to:
input, into the distribution map, required driving amount information included in the driving information; and
determine, based on an output from the distribution map, a distribution ratio candidate value.

4. The vehicle control apparatus of claim 1, wherein the plurality of distribution maps comprise a distribution map for braking safety associated with the vehicle turning at a high speed, and
wherein the instructions, when executed by the processor, further cause the vehicle control apparatus to:
input, into the distribution map, vehicle speed information and steering angle information included in the driving information; and
determine, based on an output from the distribution map, a distribution ratio candidate value.

5. The vehicle control apparatus of claim 1, wherein the plurality of distribution maps comprise a distribution map for braking safety associated with the vehicle decelerating at a high speed, and
wherein the instructions, when executed by the processor, further cause the vehicle control apparatus to:
input, into the distribution map, vehicle speed information and required braking amount information included in the driving information; and
determine, based on an output from the distribution map, a distribution ratio candidate value.

6. The vehicle control apparatus of claim 2, wherein the instructions, when executed by the processor, cause the vehicle control apparatus to determine the braking distribution ratio by:
determining the braking distribution ratio, for a front-wheel drive axle, to be one of:
a minimum value, of the plurality of distribution ratio candidate values, based on the main drive axle of the vehicle being the front-wheel drive axle, or
a maximum value, of the plurality of distribution ratio candidate values, based on the main drive axle of the vehicle being a rear-wheel drive axle.

7. The vehicle control apparatus of claim 1, wherein the instructions, when executed by the processor, further cause the vehicle control apparatus to:
determine, based on the braking distribution ratio, a main drive axle distribution ratio and an auxiliary drive axle distribution ratio;
determine, based on a signal detected by a brake pedal sensor of the vehicle, a total required braking amount; and
determine an allowable predicted value of regenerative braking of the main drive axle and an allowable predicted value of regenerative braking of the auxiliary drive axle, based on the total required braking amount, the main drive axle distribution ratio, and the auxiliary drive axle distribution ratio.

8. The vehicle control apparatus of claim 7, wherein the instructions, when executed by the processor, further cause the vehicle control apparatus to:
determine, based on the main drive axle distribution ratio, cost regenerative torque for the main drive axle; and
determine, based on the auxiliary drive axle distribution ratio, cost regenerative torque for the auxiliary drive axle.

9. The vehicle control apparatus of claim 8, wherein the instructions, when executed by the processor, cause the vehicle control apparatus to determine the first regenerative braking torque and the second regenerative braking torque by:
determining an allowable amount of regenerative braking of the main drive axle and an allowable amount of regenerative braking of the auxiliary drive axle, based on the allowable predicted value of regenerative braking of the main drive axle, the allowable predicted value of regenerative braking of the auxiliary drive axle, the cost regenerative torque for the main drive axle, and the cost regenerative torque for the auxiliary drive axle;
determining the first regenerative braking torque for the main drive axle further based on the allowable amount of regenerative braking of the main drive axle; and
determining the second regenerative braking torque for the auxiliary drive axle further based on the allowable amount of regenerative braking of the auxiliary drive axle.

10. The vehicle control apparatus of claim 1, wherein the instructions, when executed by the processor, further cause the vehicle control apparatus to:
adjust the braking distribution ratio based on whether a disconnector, which is configured to disconnect the auxiliary drive axle from a motor, is operational.

11. A vehicle control method performed by a computing device comprising a processor, the vehicle control method comprising:
collecting driving information of a vehicle;
determining, based on the driving information and a plurality of distribution maps, a braking distribution ratio between a main drive axle and an auxiliary drive axle of the vehicle;
determining, based on the braking distribution ratio, first regenerative braking torque for the main drive axle and second regenerative braking torque for the auxiliary drive axle; and
controlling, based on the first regenerative braking torque and the second regenerative braking torque, regenerative braking of the vehicle.

12. The vehicle control method of claim 11, wherein the determining of the braking distribution ratio comprises:
determining, based on the plurality of distribution maps, a plurality of distribution ratio candidate values; and
selecting, based on main drive axle information of the vehicle, one of the plurality of distribution ratio candidate values as the braking distribution ratio.

13. The vehicle control method of claim 11, wherein the plurality of distribution maps comprise a distribution map for fuel efficiency and drivability of the vehicle, and
wherein the method further comprises:
input, into the distribution map, required driving amount information included in the driving information; and
determining, based on an output from the distribution map, a distribution ratio candidate value.

14. The vehicle control method of claim 11, wherein the plurality of distribution maps comprise a distribution map for braking safety associated with the vehicle turning at a high speed, and
wherein the method further comprises:
inputting, into the distribution map, vehicle speed information and steering angle information included in the driving information; and
determining, based on an output from the distribution map, a distribution ratio candidate value.

15. The vehicle control method of claim 11, wherein the plurality of distribution maps comprise a distribution map for braking safety associated with the vehicle decelerating at a high speed, and
wherein the method further comprises:
inputting, into the distribution map, vehicle speed information and required braking amount information included in the driving information; and
determining, based on an output from the distribution map, a distribution ratio candidate value.

16. The vehicle control method of claim 12, wherein the determining of the braking distribution ratio comprises:
determining the braking distribution ratio, for a front-wheel drive axle, to be one of:
a minimum value, of the plurality of distribution ratio candidate values, based on the main drive axle of the vehicle being the front-wheel drive axle, or
a maximum value, of the plurality of distribution ratio candidate values, based on the main drive axle of the vehicle being a rear-wheel drive axle.

17. The vehicle control method of claim 11, further comprising:
determining, based on the braking distribution ratio, a main drive axle distribution ratio and an auxiliary drive axle distribution ratio;
determining, based on a signal detected by a brake pedal sensor of the vehicle, a total required braking amount; and
determining an allowable predicted value of regenerative braking of the main drive axle and an allowable predicted value of regenerative braking of the auxiliary drive axle, based on the total required braking amount, the main drive axle distribution ratio, and the auxiliary drive axle distribution ratio.

18. The vehicle control method of claim 17, further comprising:
determining, based on the main drive axle distribution ratio, cost regenerative torque for the main drive axle; and
determining, based on the auxiliary drive axle distribution ratio, cost regenerative torque for the auxiliary drive axle.

19. The vehicle control method of claim 18, wherein the determining of the first regenerative braking torque and the second regenerative braking torque comprises:
determining an allowable amount of regenerative braking of the main drive axle and an allowable amount of regenerative braking of the auxiliary drive axle, based on the allowable predicted value of regenerative braking of the main drive axle, the allowable predicted value of regenerative braking of the auxiliary drive axle, the cost regenerative torque for the main drive axle, and the cost regenerative torque for the auxiliary drive axle;
determining the first regenerative braking torque for the main drive axle further based on the allowable amount of regenerative braking of the main drive axle; and
determining the second regenerative braking torque for the auxiliary drive axle further based on the allowable amount of regenerative braking of the auxiliary drive axle.

20. The vehicle control method of claim 11, further comprising:
adjusting the braking distribution ratio based on whether a disconnector, which is configured to disconnect the auxiliary drive axle from a motor, is operational.
